(19) United States
(12) Patent Application Publication
(10) Pub. No.: US 2017/0316496 A1
(43) Pub. Date: Nov. 2, 2017

(54) SYSTEM AND METHOD FOR CREATING AND MANAGING A CHARGING CONDITION MATRIX

(71) Applicant: Bonaire Software Solutions, LLC, Boston, MA (US)

(72) Inventors: Joseph C. DiNardo, Boston, MA (US); Steven A. Crombie, North Attleboro, MA (US)

(21) Appl. No.: 15/654,213

(22) Filed: Jul. 19, 2017

Related U.S. Application Data
(63) Continuation of application No. 13/874,545, filed on May 1, 2013.

(51) Int. Cl. G06Q 40/00

(52) U.S. Cl. CPC G06Q 40/00

(57) ABSTRACT

In one embodiment, a Charging Condition Matrix (hereinafter “CCM”) is created and maintained. The CCM has one or more conditions and corresponding rates dictated by the terms and conditions of a contract. A user may utilize the CCM with a revenue and expense management application to compute data-driven fees based on attributes of the inbound data. Computed fees may subsequently be used in the processing or revenue, expenses, or both in the application.

### FIELD OF THE INVENTION

The present invention relates to revenue and expense management systems, more particularly, to calculating fees for use in a revenue or expense management or fee-billing system.

### BACKGROUND INFORMATION

Revenue and expense management and fee-billing software are important tools that assist financial institutions in performing various services such as wealth management, asset management, payment reconciliation, brokerage, etc. for its clients and vendors. Many financial institutions find that computation of fees or rebates is dependent on attributes of a given datapoint (e.g. transaction, position, etc.). For firms that compute such fees, the management of requisite systems and contracts to support the computations can be extremely difficult and costly. By way of example, a Capital Markets firm that places trades, for example to buy/sell shares of stock, will be assessed a number of fees based on the transaction. The computation of such fees is commonly dictated by the entity or organization through which the trade is made (through mutually agreed contractual terms), where different criteria determine how each fee is computed. An illustrative entity with which such a contract may be made is a stock exchange trading platform. Exemplary stock exchange platforms include, e.g., the National Association of Securities Dealers Automated Quotations (NASDAQ) System, the New York Stock Exchange (NYSE), BATS, etc. Thus, each time a trade is processed, the exchange must calculate various associated fees.

Similarly by way of example, an asset manager may manage a plurality of assets for multiple clients. Exemplary asset managers include BlackRock, UBS, etc.

The service fees assessed to the client(s) for management of a given asset may depend on the type of asset serviced (based on specific data-driven key attributes), with mutually agreed rates unique to each client. The management of referenced contracts and, correspondingly, the computation of fees derived by one-to-many data-driven attributes can be costly, time-consuming, and resource-intensive.

### SUMMARY OF THE INVENTION

The present invention overcomes the disadvantages of the prior art by providing a system and method for creating and managing a Charging Condition Matrix (hereinafter “CCM”) having one or more key attributes, conditions and corresponding rates dictated by the terms and conditions of a contract. A user may utilize the CCM with a revenue and expense management application to compute data-driven fees based on attributes of the inbound data. Computed fees may subsequently be used in the processing or revenue, expenses, or both in the application.

### BRIEF DESCRIPTION OF THE DRAWINGS

The above and further advantages of the invention may be better understood by referring to the following description in conjunction with the accompanying drawings in which like reference numerals indicate identical or functionally similar elements:

FIG. 1 is a schematic block diagram of an exemplary computer network environment in accordance with an illustrative embodiment of the present invention;

FIG. 2 is a screenshot of an exemplary graphical user interface window 200 illustrating how a user may input select attributes to be used for a CCM in accordance with an illustrative embodiment of the present invention;

FIG. 3 is a screenshot of an exemplary graphical user interface window 300 illustrating how a user may set a condition having a specific rate for the CCM in accordance with an illustrative embodiment of the present invention;

FIG. 4 is a screenshot of an exemplary graphical user interface window 400 illustrating a created CCM having conditions and corresponding rates in accordance with an illustrative embodiment of the present invention;

FIG. 5 is a screenshot of an exemplary graphical user interface window 500 illustrating loading a data-point into a revenue and expense management application and utilizing the created CCM in accordance with an illustrative embodiment of the present invention;

FIG. 6 is a screenshot of an exemplary graphical user interface window 600 illustrating calculated fee details in accordance with an illustrative embodiment of the present invention;

FIG. 7 is a screenshot of an exemplary graphical user interface window 700 for creating an invoice in accordance with an illustrative embodiment of the present invention;

FIG. 8 is a screenshot of an exemplary graphical user interface window 800 for viewing an invoice in accordance with an illustrative embodiment created by the present invention; and

FIG. 9 is a flowchart detailing the steps of a procedure for creating a CCM in accordance with an illustrative embodiment of the present invention.

### DETAILED DESCRIPTION OF AN ILLUSTRATIVE EMBODIMENT

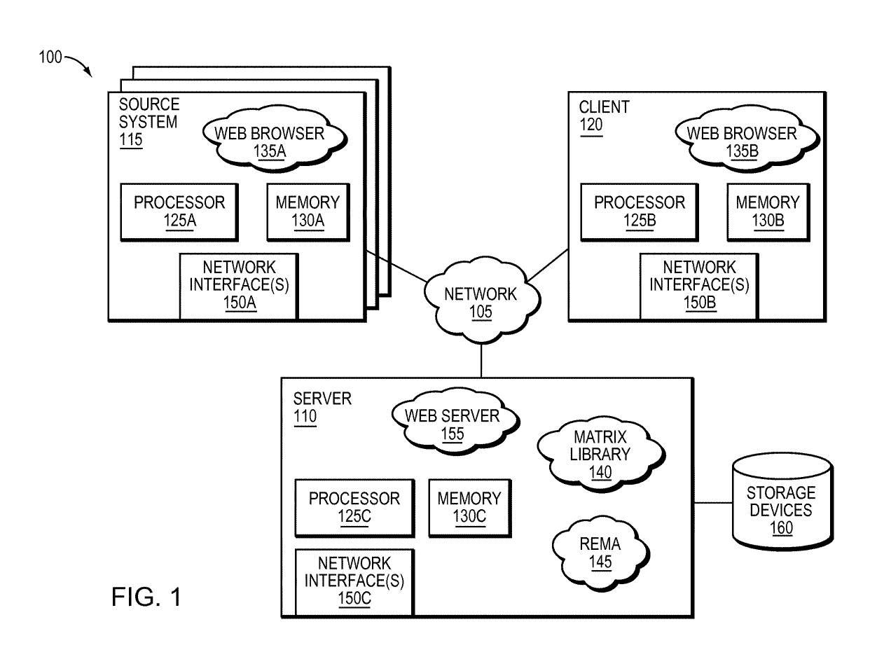

FIG. 1 is a schematic block diagram of an exemplary network environment 100 in which the principles of the present invention may be implemented in accordance with an illustrative embodiment of the present invention. The environment 100 is centered around a network 105 that may comprise any conventional form of networking including, for example, a TCP/IP network, a virtual private network (VPN), a local area network (LAN) or a wide area network (WAN), such as the well-known Internet. As will be appreciated by those skilled in the art, the network 105 may comprise a plurality of different networks (not shown). It should be noted that various networks may comprise differing types and/or protocols in accordance with alternative embodiments of the present invention. Portions of network 105 may comprise wired networks, wireless networks, etc., in accordance with various alternative embodiments of the present invention.

Operatively interconnected over the network 105 is a server 110, one or more source systems 115, and a client 120. The server 110, source system 115, and client 120 each include one or more network interfaces 150 (e.g., 150A, 150B, 150C), a processor 125 (e.g., 125A, 125B, and 125C), and a memory 130 (e.g., 130A, 130B, 130C). The network interfaces 150 contain the mechanical, electrical, and signaling circuitry for communicating data over physical links coupled to the network 100. The network interfaces may be configured to transmit and/or receive data using a variety of different communication protocols, including, inter alia, TCP/IP, UDP, ATM, synchronous optical networks (SONET), wireless protocols, Frame Relay, Ethernet, Fiber Distributed Data Interface (FDDI), etc. Notably, a physical network interface 150 may also be used to implement one or more virtual network interfaces, such as for Virtual Private Network (VPN) access, known to those skilled in the art.

The memory 130 comprises a plurality of locations that are addressable by the processor 125 and the network interfaces 150 for storing software programs and data structures associated with the illustrative embodiments described herein. The processor 125 may comprise necessary elements and/or logic adapted to execute the software programs and manipulate the data structures.

Source Systems 115 and client 120 each further include web browser 135 (e.g., 135A and 135B) that may be utilized as a software application for retrieving, presenting and traversing information resources on the World Wide Web. For example, web browser 135 may be utilized to manipulate or obtain data and/or data structures via web server 155 of server 110. The data may be stored in the memory 130C of server 110 or storage device(s) 160 connected to server 110. Storage device(s) 160 are illustratively disk drives, however, in alternate embodiments, the storage device(s) 160 may comprise any form of storage, including, e.g., Flash RAM, battery backed non-volatile random access memory (NVRAM), etc. As such, the description of storage device(s) 160 as disks should be taken as exemplary only.

Server 110 further includes revenue and expense management application 145 (hereinafter “REMA”) that performs various functions associated with revenue and expense management, fee-billing, and the creation and management of a CCM in accordance with an illustrative embodiment of the present invention. Matrix library 140 may store and organize the created CCMs. Matrix library 140 may also store CCMs, including, e.g., CCMs that are created during operation as well as a library of generic CCMs that may be utilized in accordance with an illustrative embodiment of the present invention.

As an illustrative example, assume that trading firm X has a contractual agreement with BATS. The contractual agreement dictates how trades, issued by the trading firm on behalf of its clients, are charged. For example, the contractual agreement may state that purchases of stock (buys) are assigned a rate of 7 cents per 10 shares traded, sales of stock (sells) are assigned a rate of 5 cents per 10 shares traded, trades for 10,000+ shares are given a 30% discount, and any stock whose share price is less than $1 (regardless of buy/sell) are assigned a rate of 15 cents per 10 shares traded. These contractual terms and conditions are the basis for the Charging Condition Matrix (CCM); the CCM is a digital representation of the contract used for referential and computational purposes. It is noted that this contractual agreement is exemplary in nature and any terms may be used (in the herein described capital markets example, or in other financial sectors such as asset management).

The contractual agreement and its conditions as described above can be used to create a conceptual matrix with the following (5) conditions:

| Transaction Type | Units Traded | Share Price | Rate |
|---|---|---|---|
| Buy | <10,000 | >=1 | .007 |
| Sell | <10,000 | >=1 | .005 |
| Buy | >=10,000 | >= | .0049 |
| Sell | >=10,000 | >=1 | .0035 |
| ALL | ALL | <1 | .015 |

It is noted that to create the conceptual matrix above, the rates have been simplified by first dividing the rate by 1,000,000 to reflect a per-share rate (instead of per-ten-shares), and second by incorporating the bulk discount in the 3^{rd} and 4^{th} rows. The conditions are defined by values of the key attributes (transaction type (e.g., buy or sell), units traded and share price) that define the trade. Thus, each row represents a condition and corresponding rate for the matrix, where the rate can then be applied to a data element (in this example, a trade). Similarly, the first three columns are the key attributes used in this contract, and are duly configured in the CCM. It is noted that contractual terms and conditions, and key attributes, differ greatly within the industry. For instance, while BATS may qualify a trade based on the three attributes above, an FX broker may qualify a trade based on completely different attributes (e.g., buy currency, sell currency, and settlement days). The key attributes utilized drive the conditions that make up the CCM.

The conceptual matrix above may then be utilized to create the CCM. Specifically, REMA 145 may present, through web server 155, one or more graphical user interfaces (GUIs) to users via web browser 135B to create and manage a CCM. Alternate UI techniques may be utilized with the present invention in alternate embodiments. For example, the REMA may present a command line interface (CLI) that permits users to create and manage the CCM. Similarly, the REMA may accept as input a text file in Extended Markup Language (XML) form. The REMA would, in such circumstances, convert and store this textual information into a CCM to be stored in the Data Repository 160. As such, the description of the GUI screenshots described herein should be taken as exemplary only and not to limit the scope of the present invention.

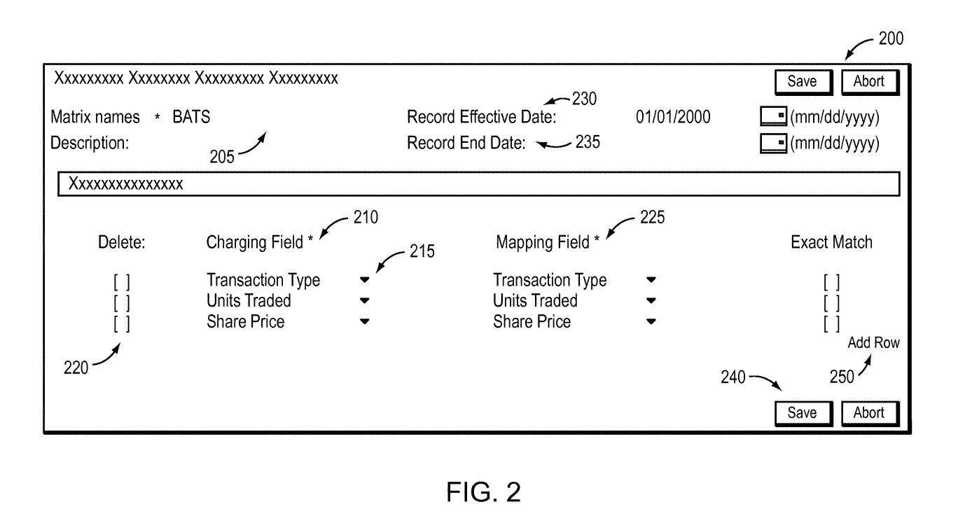

FIG. 2 is a screenshot of an exemplary GUI window 200 illustrating how a user may input key attributes to be used for a CCM in accordance with an illustrative embodiment of the present invention. The window 200 may be generated for display in web browser 135B in accordance with an illustrative embodiment of the present invention. The window 200 includes a matrix name field 205 that allows a user to name the matrix. In this example, the matrix has been named “BATS” Further, window 200 includes one-to-many charging fields 210 that correspond to the key attributes used to define the CCM. For example, and with reference to the BATS example described above, the one or more attributes are transaction type (e.g., buy or sell), number of units traded, and a share price may be selected. As such, the user may select arrow 215 to select the key attributes from the drop down menus. A delete button 220 enables a user to remove one of the key attributes from the CCM. A mapping field 225 enables a user to define what internal, to the REMA, key attribute name is associated with a given charging field 210. This may be utilized when, e.g., a key attribute name received from an upstream data source (e.g., source system 115) differs from an internal attribute name. An effective date field 230 and end date field 235 are used to set a time period for which a CCM is to be utilized. Correspondingly, multiple versions of the same CCM may be created, having contiguous and non-overlapping effective dates. This feature enhances management of CCMs which may change over time, and utilized to accurately reflect historical and future changes. Illustratively, the end date field 235 may be left blank to indicate that the CCM should be used indefinitely. In alternate embodiments, the user may be required to type in the key attributes. Further, the user may add an additional key attribute by selecting the add row button 250. To save the attributes for the CCM, the user may select the save button field 240.

While this description has included fields, buttons and drop down menus components of a GUI, it should be noted that any GUI components may be utilized without departing from the spirit or scope of illustrative embodiments of the present invention. As such, the description of the various components of any of the GUIs described herein should be taken as exemplary only.

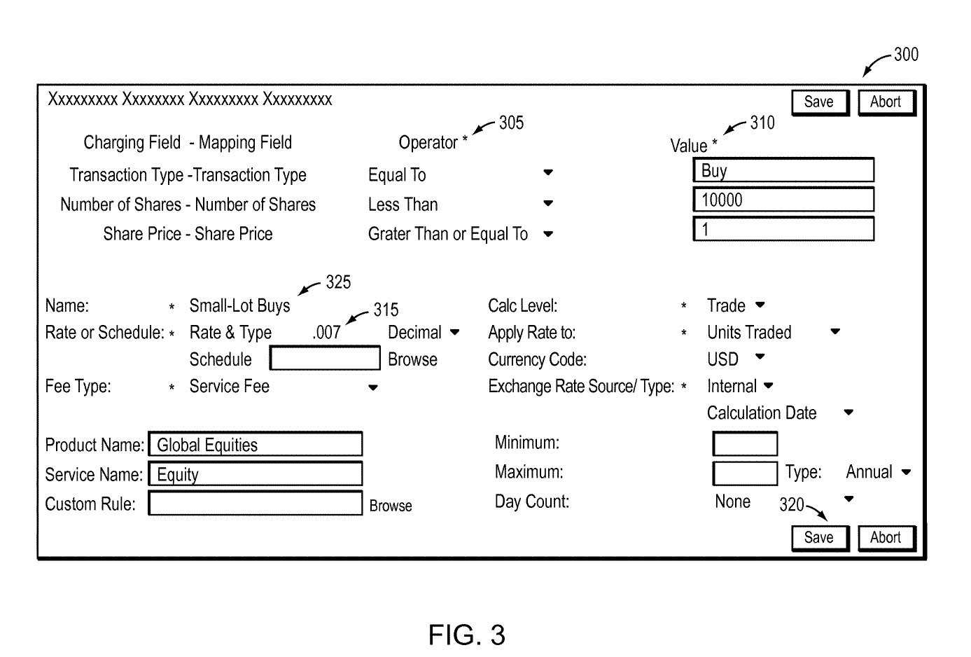

FIG. 3 is a screenshot of an exemplary GUI window 300 illustrating how a user may set a condition having a specific fee structure for the CCM in accordance with an illustrative embodiment of the present invention. Window 300 may have operator fields 305 and value fields 310 associated with the previously selected key attributes. For example, and with reference to the BATS example described above, a purchase (e.g., buy) of stocks of less than 10,000 shares where each share price is greater than $1 has a corresponding rate of 0.007. The user may enter a name in name field 325 to name the condition. For example, the name may be “small-lot buys”, generally reflective of the conditions which must be met to trigger a fee calculation. To set this condition and corresponding rate for the CCM, the user may first select values for operator field 305 and value field 310 for each attribute. Specifically, in this example and for attribute transaction type, operator field 305 may be set to “equal to” and value field 310 may be set to “buy.” Further, for attribute number of shares, operator field 305 may be set to “less than” and value field 310 may be set to “10,000.” Moreover, for share price attribute, operator field 305 may be set to “greater than or equal to” and value field 310 may be set to “1.” It is noted that the user may select the values from a drop down menu or may manually input the values. Once the attributes for the condition are set, the user may then set the corresponding rate by entering the rate of “0.007” in the Rate & Type field 315. The condition and corresponding rate may then be saved by selecting the save button 320. The user then may set the other conditions and corresponding rates for the CCM as described above in the exemplary conceptual matrix. Once all the conditions and the corresponding rates have been set, the created and functioning CCM may be utilized to calculate trade fees using a rules-based (e.g. RETE) algorithm in accordance with an illustrative embodiment of the present invention.

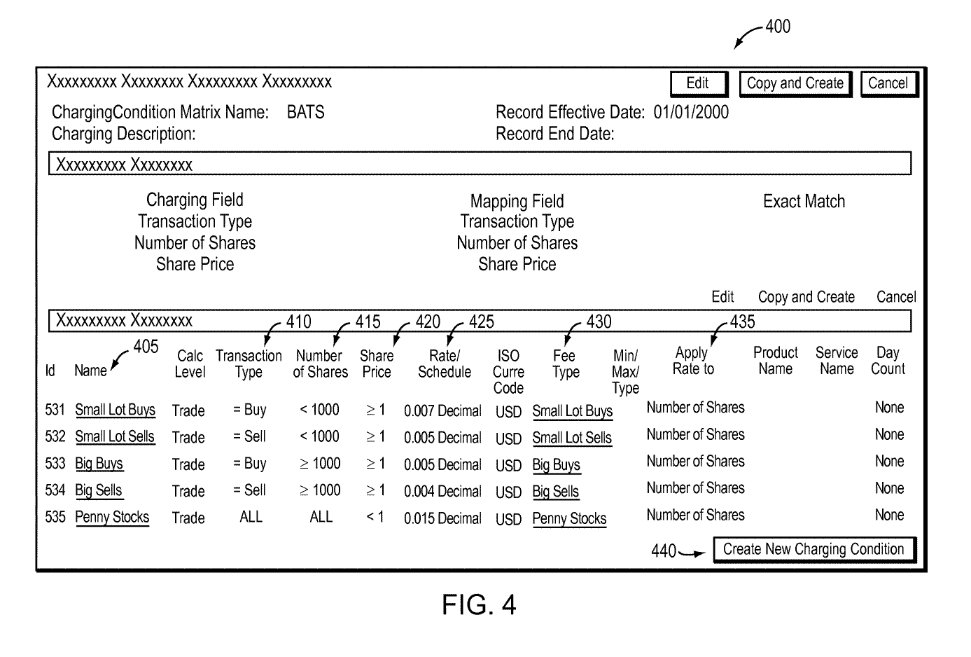

FIG. 4 is a screenshot of an exemplary GUI window 400 illustrating a created CCM having conditions and corresponding rates in accordance with an illustrative embodiment of the present invention. Specifically, the window 400 corresponds to the example described above and illustrated in the conceptual matrix. Window 400 illustratively includes a plurality of rows that include a name field 405, key field ‘transaction type’ field 410, key field ‘number of shares’ field 415, key field ‘share price’ field 420, rate/schedule field 425, fee type field 430, and apply rate to field 435. In alternative embodiments, additional and/or different fields may be utilized. As such, the description of specific fields should be taken as exemplary only. Name field 405 includes a name of each condition that makes up the CCM. For example, the names may be “small-lot buy” and “small-lot sell.” Transaction type field 410, number of share field 415, and share price field 420 represent the attributes for the CCM and have value for each respective condition of the CCM. Moreover, rate/schedule field 425 has a rate value or multi-tiered fee schedule for each condition of the CCM. Fee type field 430 indicates the type of fee being charged. In this example, since the fees are associated with trades, the fee type field 430 has the same value as the name of each respective Charging Condition. Finally, apply rate to field 435 indicates the manner in which the rate, in rate/schedule field 425, should be applied to the transaction. In this example, apply rate to field 435 indicates “number of shares”, meaning that the rate (e.g., 0.0007) should be applied to the number of shares in the transaction. An unlimited number of additional Charging Conditions may be added to the matrix by selecting the create new charging condition button 440.

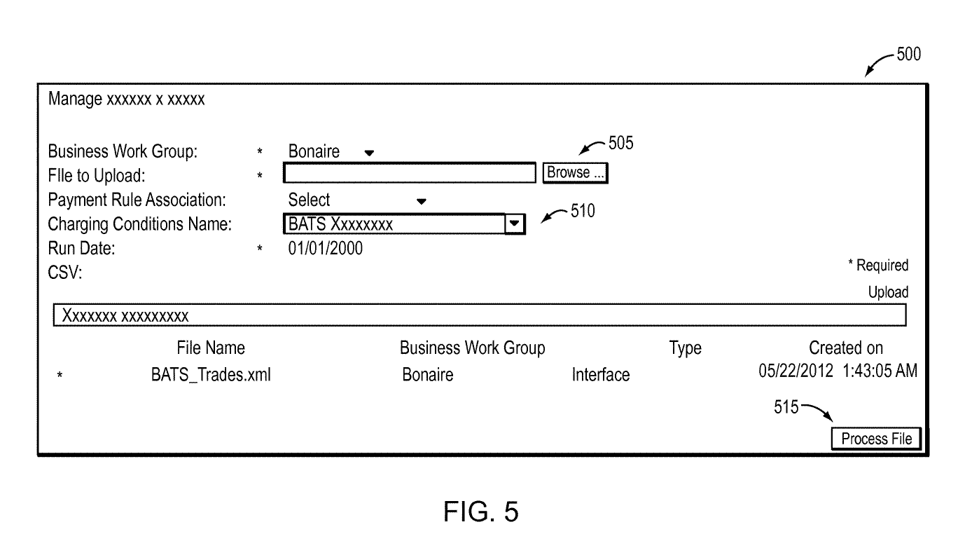

FIG. 5 is a screenshot of an exemplary GUI window 500 illustrating loading a trade into a revenue and expense management application (REMA) and utilizing the created CCM in accordance with an illustrative embodiment of the present invention. Window 500 includes file to upload field 505 that allows a user, such as an asset manager or expense analyst, to select a data file to upload. The data file will include numerical elements/attributes (e.g. transactions, positions, markets values, etc.) intended for upload to and subsequent use in the application. Charging condition field 510 allows the user to select a CCM with which to process the upload file (and correspondingly calculate data-specific fees). Specifically, the user may select the file from a directory or folder. For example, the user may utilize web browser 135 on client 120 to access server 110. The user may then associate the file with a CCM from the matrix library 140. Once selected, the user may select the process file button 515 to calculate the fees for the data within the file.

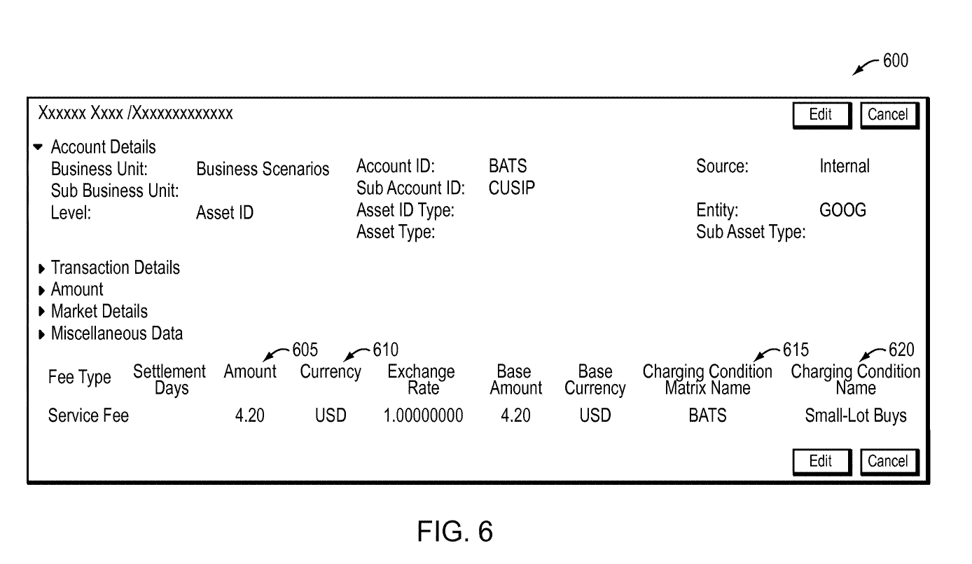

FIG. 6 is a screenshot of an exemplary GUI window 600 illustrating data with fee details in accordance with an illustrative embodiment of the present invention. Window 600 includes amount field 605 that indicates the fee(s) calculated by the CCM for this data element. Further, currency field 610 indicates the currency of the amount in the amount field 605. Moreover, charging condition matrix name field 615 indicates the name of the CCM utilized to compute the fee(s), and charging condition name field 620 indicates the charging condition(s) within the CCM that matched with the key attributes of the data element.

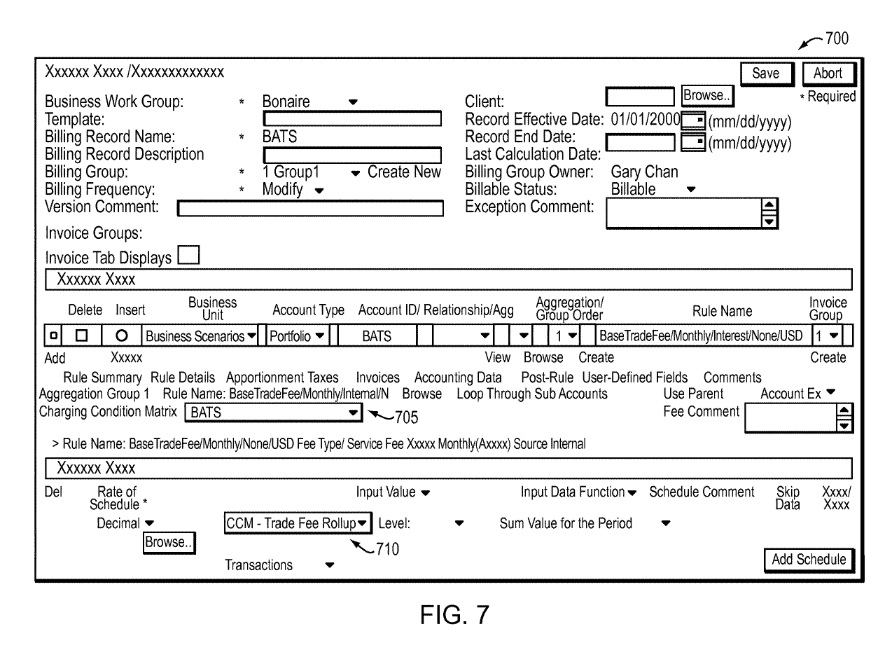

FIG. 7 is a screenshot of an exemplary GUI window 700 for creating an invoice in accordance with an illustrative embodiment of the present invention. Specifically, the creation of the invoice, utilizing window 700, rolls up the data fees by user-configurable logic into one (or many) invoice(s). Window 700 includes charging condition matrix field 705 that allows the user, for example using web browser 135B, to select the CCM for which it wants to create the invoice. Further, type field 710 includes “CCM-trade fee rollup” to indicate that the desired function is an aggregation of fees calculated using the CCM.

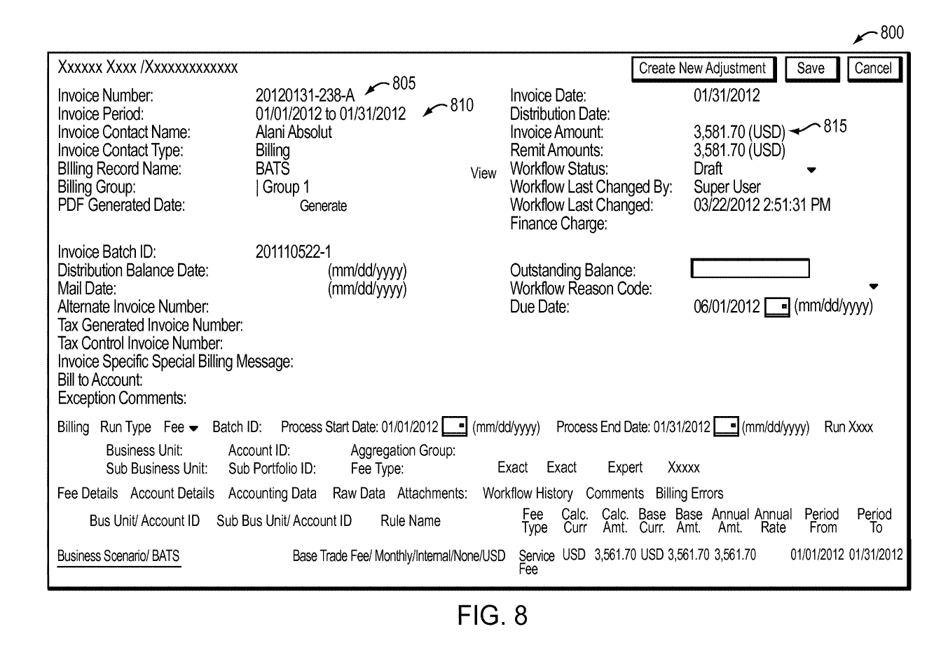

FIG. 8 is a screenshot of an exemplary GUI window 800 for a creating an invoice in accordance with an illustrative embodiment of the present invention. Window 800 includes invoice number field 805 that indicates a system-generated id assigned to the invoice. Invoice period field 810 indicates the time period for which the invoice corresponds. In this example, the invoice is for a period of one month, from Jan. 1, 2012 through Jan. 31, 2012. Further, invoice amount field 815 indicates the amount associated with the invoice for aggregated fees associated with the CCM. In this example, the total fee amount is $3,561.70.

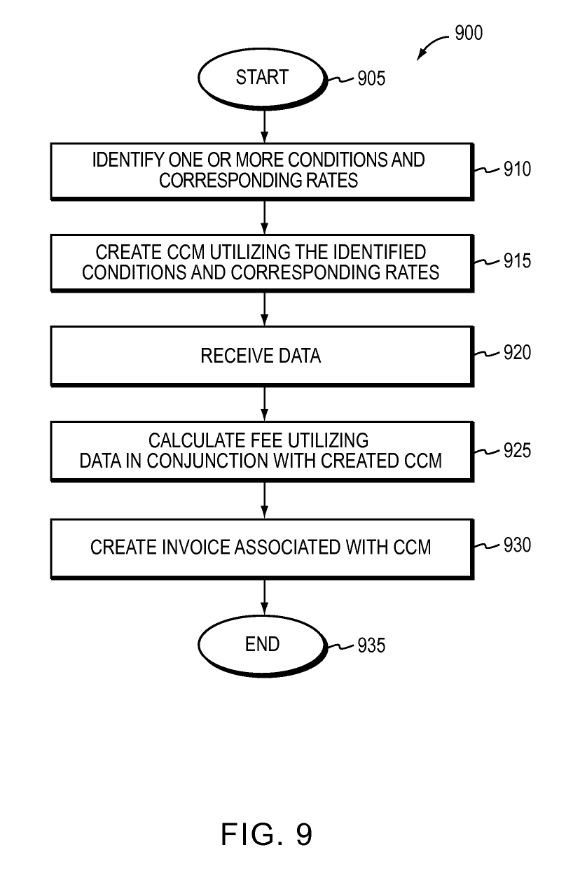

FIG. 9 is a flowchart detailing the steps of a procedure 900 for creating and managing a CCM in accordance with an illustrative embodiment of the present invention. The procedure 900 starts at step 905 and continues to step 910, where one or more conditions and corresponding rates are identified according to the terms and conditions of a contract. At step 915, a CCM may be created utilizing the identified conditions and corresponding rates. At step 920, data may be received by the application. For example, a trade file may be received containing one-to-many transactions with attributes (e.g., buy or sell for specific stocks, number of shares, etc.). Also by example, a position file may be received containing one-to-many market values with attributes (e.g. asset type, sub-asset type, etc.). At step 925, the data fee is calculated using rules-based (e.g. RETE) algorithms in conjunction with the CCM created in step 915. Specifically, the attributes of the data may align with (e.g., trigger) a particular charge condition that has a corresponding rate. Thus, the fee may be calculated utilizing the apply rate to field indicated in the charging condition and the corresponding rate. At step 930, an invoice is created for the CCM. This step is optional, and may be used for e.g. the billing of fees as revenue, the processing and reconciliation of incoming invoices as expenses, etc. The procedure ends at step 935.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on one or more tangible (non-transitory) computer-readable storage media (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
electronically, obtaining, by at least one specifically programmed trading computer system, over a computer system, from at least one other computer system, utilizing at least one first graphical user interface, a first plurality of attributes whose values determine a first plurality of trading conditions that determine a first plurality of corresponding rates, which are charged by at least one first entity in accordance with at least one first contract, being associated with at least one first entity and related to trading at least one first financial asset, wherein each value of the values of the first plurality of attributes is one of a quantitative value, a qualitative value, and any combination thereof;
automatically creating, by the at least one specifically programmed trading computer system, at least one first Charging Condition Matrix (CCM) which is:
i) associated with at least one first entity that charges fees for trading the at least one first financial asset,
ii) a first group of trading conditions and corresponding rates which is based on the first plurality of trading conditions and the first plurality of corresponding rates defined by the first plurality of attributes in the at least one first contract associated with the at least one first entity, and
iii) active during at least one first time period;
electronically, obtaining, by the at least one specifically programmed trading computer system, over the computer system, from the at least one other computer system, utilizing at least one second graphical user interface, a second plurality of attributes whose values determine a second plurality of trading conditions that determine a second plurality of corresponding rates, which are charged by at least one second entity in accordance with at least one second contract, being associated with at least one second entity and related to trading at least one second financial asset, wherein each value of the values of the second plurality of attributes is one of a quantitative value, a qualitative value, and any combination thereof;
automatically creating, by the at least one specifically programmed trading computer system, at least one second CCM which is:
i) associated with at least one second entity that charges fees for trading the at least one second financial asset,
ii) a second group of trading conditions and corresponding rates which is based on the second plurality of trading conditions and the second plurality of corresponding rates defined by the second plurality of attributes in the at least one second contract associated with the at least one second entity, and
iii) active during at least one second time period;
automatically storing, by the at least one specifically programmed trading computer system, in an at least one database, a library of CCMs, wherein the library of CCMs comprises the at least one first CCM and the at least one second CCM; and
at a time of real-time processing of each particular trade in at least one particular financial asset:
a) selecting, in real-time, by the at least one specifically programmed trading computer system, from the library of CCMs stored in the at least one database, a particular CCM associated with a particular entity related to such particular trade,
b) calculating, in real-time, by the at least one specifically programmed trading computer system, based on the particular CCM, a particular fee for such particular trade, and
c) outputting, in real-time, by the at least one specifically programmed trading computer system, the particular fee for such particular trade.

2. The method of claim 1, further comprising:
automatically creating, in real-time, by the at least one specifically programmed trading computer system, an invoice associated with the particular trade, wherein the invoice includes the particular.

3. The method of claim 1, wherein the first plurality of attributes and the second plurality of attributes comprise attributes identifying at least one of a transaction type and an asset type.

4. The method of claim 1 wherein the at least one first contract and the at least one second contract are selected from the group consisting of:
a transaction execution contract,
an asset management contract, and a distribution contract associated with an exchange.

5. The method of claim 4, wherein the at least one first entity and the at least one second entity are selected from the group consisting of a stock exchange, an asset manager, and a mutual fund.

6. A computer-implemented specifically programmed trading system, comprising:
at least one network interface adapted to communicate data over a computer network;
at least one processor coupled to the at least one network interface and adapted to execute at least one process; and
a non-transient memory configured to store the at least one process executable by the processor, the least one process when executed is operable to:
electronically obtain, over a computer system, from at least one other computer system, utilizing at least one first graphical user interface, a first plurality of attributes whose values determine a first plurality of trading conditions that determine a first plurality of corresponding rates, which are charged by at least one first entity in accordance with at least one first contract, being associated with at least one first entity and related to trading at least one first financial asset, wherein each value of the values of the first plurality of attributes is one of a quantitative value, a qualitative value, and any combination thereof;
automatically create at least one first Charging Condition Matrix (CCM) which is:
i) associated with at least one first entity that charges fees for trading the at least one first financial asset,
ii) a first group of trading conditions and corresponding rates which is based on the first plurality of trading conditions and the first plurality of corresponding rates defined by the first plurality of attributes in the at least one first contract associated with the at least one first entity, and
iii) active during at least one first time period;
electronically obtain, over the computer system, from the at least one other computer system, utilizing at least one second graphical user interface, a second plurality of attributes whose values determine a second plurality of trading conditions that determine a second plurality of corresponding rates, which are charged by at least one second entity in accordance with at least one second contract, being associated with at least one second entity and related to trading at least one second financial asset, wherein each value of the values of the second plurality of attributes is one of a quantitative value, a qualitative value, and any combination thereof;
automatically create at least one second CCM which is:
i) associated with at least one second entity that charges fees for trading the at least one second financial asset,
ii) a second group of trading conditions and corresponding rates which is based on the second plurality of trading conditions and the second plurality of corresponding rates defined by the second plurality of attributes in the at least one second contract associated with the at least one second entity, and
iii) active during at least one second time period;
automatically store, in an at least one database, a library of CCMs, wherein the library of CCMs comprises the at least one first CCM and the at least one second CCM; and
at a time of real-time processing of each particular trade in at least one particular financial asset:
a) select, in real-time, from the library of CCMs stored in the at least one database, a particular CCM associated with a particular entity related to such particular trade,
b) calculate, in real-time, based on the particular CCM, a particular fee for such particular trade, and
c) output, in real-time, the particular fee for such particular trade.

7. The computer-implemented specifically programmed trading system of claim 6, wherein the least one process when executed is further operable to:
automatically create, in real-time, an invoice associated with the particular trade, wherein the invoice includes the particular fee.

8. The computer-implemented specifically programmed trading system of claim 6, wherein the first plurality of attributes and the second plurality of attributes comprise attributes identifying at least one of a transaction type and an asset type.

9. The computer-implemented specifically programmed trading system of claim 6, wherein the at least one first contract and the at least one second contract are selected from the group consisting of a transaction execution contract, an asset management contract, and a distribution contract associated with an exchange.

10. The computer-implemented specifically programmed trading system of claim 6, wherein the at least one first entity and the at least one second entity are selected from the group consisting of a stock exchange, an asset manager, and a mutual fund.
